(19) United States
(12) Patent Application Publication
(10) Pub. No.: US 2026/0273728 A1
(43) Pub. Date: Sep. 17, 2026

(54) SCARA ROBOT

(71) Applicant: ABB SCHWEIZ AG, Baden (CH)

(72) Inventors: Jiafan Zhang, Shanghai (CN); Kaiyuan Cao, Shanghai (CN); Zhiwei Li, Shanghai (CN); Changting Chen, Shanghai (CN)

(21) Appl. No.: 19/671,905

(22) Filed: May 8, 2026

Related U.S. Application Data
(63) Continuation of application No. PCT/CN2023/132272, filed on Nov. 17, 2023.

(51) Int. Cl. B25J 9/04; B25J 5/02; B25J 19/00

(52) U.S. Cl. CPC B25J 9/042; B25J 5/02; B25J 19/0075

(57) ABSTRACT

A SCARA robot includes a base including a prismatic joint and a plurality of arm parts connected to the base and arranged in serial. Two adjacent arm parts each include an arm body, the arm body including a tubular body with a first opening extending in a first direction parallel to the prismatic joint and a second opening extending in a second direction perpendicular to the first direction, and a first actuator for forming a first revolute joint of the SCARA robot is arranged in the first opening, a fixed part of the first actuator being fixed to the one arm part, and a movable part of the first actuator being fixed to the other arm part of the two adjacent arm parts.

### FIELD

Embodiments of the present disclosure generally relate to a four-axis robot, in particular, a Selective Compliance Assembly Robot Arm, SCARA, robot.

### BACKGROUND

SCARA robots are one of the most common forms of industrial robots in current industrial field. Different from 6-axis robots, a SCARA robot typically takes a four-axis configuration, i.e., one prismatic axis which allows its robotic arm to perform a linear movement, and three parallel revolute axes which allows the robotic arm to rotate. SCARA robots are suitable for mechanical automation in many industrial fields, such as automatic assembly, painting, handling, welding and so on.

Typically, a SCARA robot uses painted aluminum castings as their structural parts which are not optimal in terms of corrosion resistance and cleanroom. Also, joints and robot structure parts in the four-axis configuration of the SCARA robot are different from each other. This results in high manufacturing costs and maintenance costs of the SCARA robot. There is a need to improve the conventional four-axis configuration of the SCARA robot.

### SUMMARY

Example embodiments of the present disclosure provide a SCARA robot with modular configuration to reduce manufacturing costs and maintenance costs and to improve assembly efficiency.

In a first aspect of the present disclosure, there is provided a selective compliance assembly robot arm SCARA robot. The SCARA robot comprises a base comprising a first connection interface, the first connection interface defining a prismatic joint of the SCARA robot; and a plurality of arm parts connected to the base and arranged in serial; wherein at least two adjacent arm parts of the plurality of arm parts each comprise an arm body, the arm body comprising a tubular body with a first opening extending in a first direction parallel to the prismatic joint and a second opening extending in a second direction perpendicular to the first direction, and a first actuator for forming a first revolute joint of the SCARA robot is arranged in the first opening of one arm part of the two adjacent arm parts, a fixed part of the first actuator being fixed to the one arm part, and a movable part of the first actuator being fixed to the other arm part of the two adjacent arm parts.

With this arrangement, a link can be transformed into a joint without any modification to the modular arm part. Provision of the modular arm parts can reduce the total number of components of the SCARA robot, with reduced manufacturing costs and improved assembly efficiency.

In some embodiments, the two adjacent arm parts may be made of plastic material.

In some embodiments, the tubular body may comprise a first circumferential wall extending lengthwise along the tubular body around the first opening, and the fixed part of the actuator is circumferentially fixed to the one arm part via the first circumferential wall.

In some embodiments, the tubular body may comprise a second circumferential wall extending lengthwise along the tubular body around the second opening, and the other arm part is circumferentially fixed to the second circumferential wall; or the tubular body comprises an inner flange extending radially from an inner wall surface of the tubular body around the second opening, and the other arm part is fixed to the first inner flange.

In some embodiments, the tubular body may comprise a first inner flange extending radially from an inner wall surface of the tubular body around the first opening, and the fixed part of the actuator is axially fixed to the first inner flange.

In some embodiments, the tubular body may comprise a circumferential wall extending lengthwise along the tubular body around the second opening, and the other arm part is circumferentially fixed to the circumferential wall; or the tubular body comprises a second inner flange extending radially from an inner wall surface of the tubular body around the second opening, and the other arm part is radially fixed to the second inner flange.

In some embodiments, the two adjacent arm parts may be directly fixed to an arm part, of the plurality of arm parts, for receiving a tool, or is indirectly fixed to the arm part for receiving the tool via a first link arm part.

In some embodiments, the arm part for receiving a tool may comprise an arm body, the arm body comprising a tubular body with a first opening extending in the first direction parallel to the prismatic joint and a second opening extending in the second direction perpendicular to the first direction, and a second actuator for forming a second revolute joint of the SCARA robot is arranged in the first opening of the arm part for receiving a tool, a fixed part of the second actuator being fixed to the for receiving the tool, and a movable part of the second actuator configured to receive the tool.

In some embodiments, the SCARA robot may further comprise a second pair of two adjacent arm parts of the plurality of arm parts, wherein the second pair of two adjacent arm parts is connected to the base at the first connection interface and each comprises an arm body, the arm body comprising a tubular body with a first opening extending in the first direction parallel to the prismatic joint and a second opening extending in the second direction perpendicular to the first direction, and a third actuator for forming a third revolute joint of the SCARA robot is arranged in the first opening of one arm part of the second pair, a fixed part of the third actuator being fixed to the one arm part of the second pair, and a movable part of the third actuator being fixed to the other arm part of the second pair.

In some embodiments, a second pair of two adjacent arm parts may be directly fixed to the two adjacent arm parts of the plurality of arm parts, or is indirectly fixed to the two adjacent arm parts of the plurality of arm parts via a second link arm part.

In some embodiments, the first opening of an arm part of the second pair of two adjacent arm parts that is adjacent to the base may be downwardly oriented.

In some embodiments, one arm part, of the plurality of arm parts, connected to the base may comprise an arm body comprising a tubular body with a first opening extending in the first direction parallel to the prismatic joint and a second opening extending in the second direction perpendicular to the first direction, and a third actuator for forming a third revolute joint of the SCARA robot is arranged in the first opening of the one arm part connected to the base, a fixed part of the third actuator being fixed to the one arm part connected to the base, and a movable part of the third actuator is connected to the base at the first connection interface.

In some embodiments, the base may further comprise an enclosure defining a sealing environment in which the prismatic joint is arranged.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective view of a SCARA robot including modular configuration according to a first example embodiment of the present disclosure;

FIG. 2 is a plane exploded view of a SCARA robot according to one example embodiment of the present disclosure;

FIG. 3 is a modular arm body according to a first example embodiment of the present disclosure;

FIG. 4 is an assembled view of the modular arm body of FIG. 3 assembled with an actuator;

FIG. 5 is a modular arm body according to a second example embodiment of the present disclosure;

FIG. 6 is a sectional view of the modular arm body of FIG. 5;

FIG. 7 is a modular arm body according to a third example embodiment of the present disclosure;

FIG. 8 is a plane exploded view of a SCARA robot according to a second example embodiment of the present disclosure;

FIG. 9 is a perspective view of a SCARA robot according to a third example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

The SCARA robot typically includes a plurality of links and joints. These links and joints are typically of a low modular level. One link or joint cannot be used in another joint or link. Manufacturing costs and maintenance costs of the SCARA robot are thus high. According to the present disclosure, there proposes a novel SCARA robot in which modular arm parts are utilized in links and/or joints. As modular arm parts are utilized, an actuator for forming a joint can be selectively attached on the modular arm part. In this way, a link can be easily transformed into a joint without any modification to the modular arm part. According to the present disclosure, at least a first pair of two adjacent arm parts of the plurality of arm parts each comprise an arm body, the arm body comprising a tubular body with a first opening extending in a first direction parallel to the prismatic joint and a second opening extending in a second direction perpendicular to the first direction, and a first actuator for forming a first revolute joint of the SCARA robot is arranged in the first opening of one arm part of the first pair of two adjacent arm parts, a fixed part of the first actuator being fixed to the one arm part, and a movable part of the first actuator being fixed to the other arm part of the first pair of two adjacent arm parts. Provision of the modular arm parts can reduce the total number of components of the SCARA robot, with reduced manufacturing costs and improved assembly efficiency.

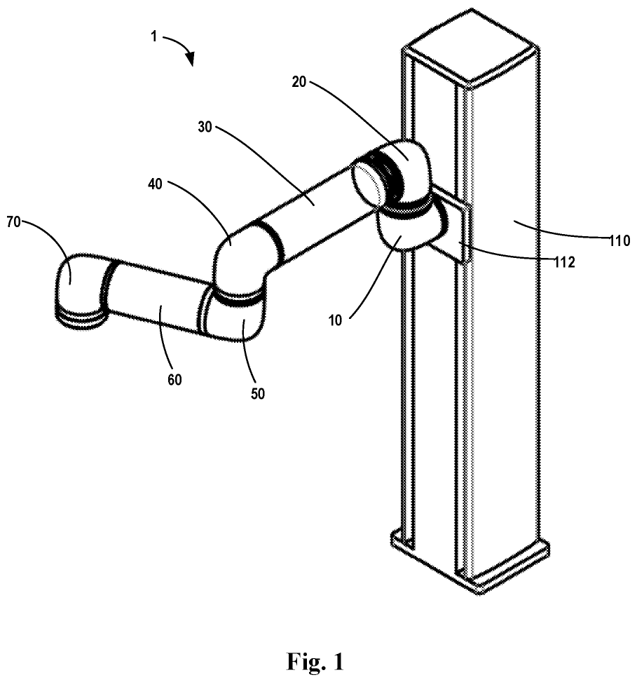

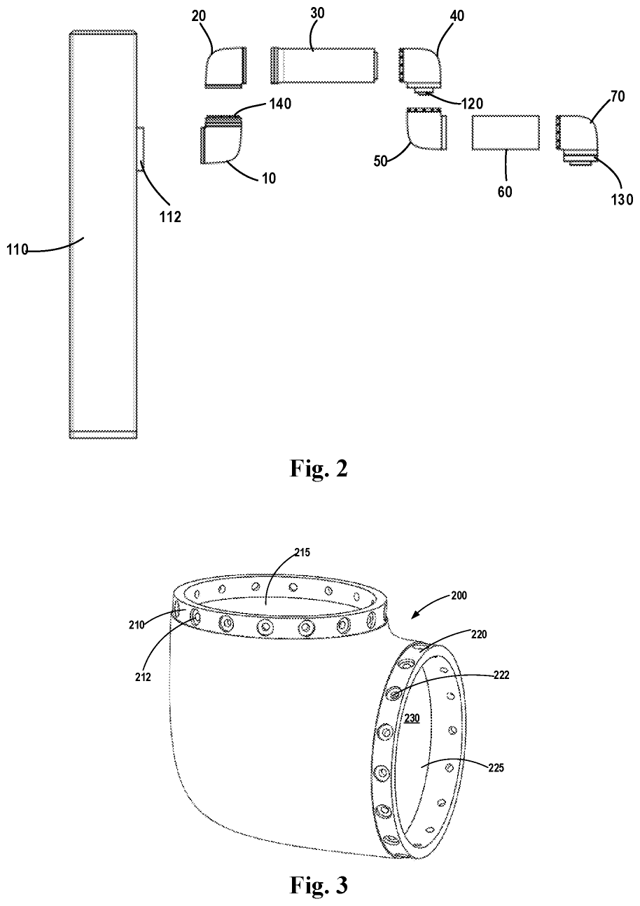

FIGS. 1 and 2 illustrates a SCARA robot including modular configuration according to a first example embodiment of the present disclosure. As shown in FIGS. 1 and 2, the SCARA robot include a base 110 and a plurality of arm parts 10, 20, 30, 40, 50, 60, 70 arranged in serial. Two pair of two adjacent arm parts, i.e., 10, 20 and 40, 50 is formed as modular configuration. The two adjacent arm part is of substantially the same configuration. Each arm part may include a tubular body with a first opening extending in a first direction parallel to the prismatic joint and a second opening extending in a second direction perpendicular to the first direction. Two actuators (each may include an electrical motor, the associated gearbox, and the like) may be selectively arranged in one of arm part of the respective pair of two adjacent arm part. By attaching the actuator onto one of the pair of the two adjacent arm parts, a link or an arm par can be modified as a joint of the SCARA without any change to the structure of the arms. Other arm parts which are not assembled with the actuators may be used as links of the SCARA.

As shown in FIG. 2, the base 110 comprises a first connection interface 112. An arm part 10 is connected to the base 110. In the shown example, the first connection interface 112 is a prismatic joint. A pair of two adjacent arm parts 10, 20 are connected to the base. When the arm part 10 is connected to the base 110, the arm part 10 and thus the whole SCARA move linearly along the base 10. This is advantageous in many applications. Due to the fact that the prismatic joint is arranged at the base 10, a size or space occupied by the SCARA can be significantly reduced. This makes it possible for the tool mounted on the end effector to work in a narrow space.

In the shown example, the arm part 10 is used as a joint. As shown in FIG. 2, an actuator 140 is fixed to the arm part 10. The actuator 140 includes a fixed part and a movable part. The fixed part, among the others, includes a stator of a motor. The fixed part may include a first joint interface for fixing the fixed part to the arm part 10. The fixed part of the actuator 140 is fixed to the arm part 10. The movable part, among the others, includes a rotor of the motor and a reduction gear connected to the rotor. The rotor is configured to rotate around an axial direction (i.e. the vertical direction in the figure). The movable part further includes a second joint interface. Components to be driven by the actuator 140, i.e., the arm parts 20, 30, 40, 50, 60, 70 subsequent to the arm part 10, may be further connected to the movable part via the second joint interface. The joint formed by the actuator 140 and the arm part 10 is a first revolute joint of the SCARA robot. In the shown example, the first revolute joint is in the vertical direction. Thus, as the second actuator 140 rotates, the arm parts 20, 30, 40, 50, 60, 70 subsequent to the arm part 10 rotates around the vertical direction accordingly.

Accordingly, as the rotor of the actuator 140 rotates, the arm parts 20, 30, 40, 50, 60, 70 subsequent to the arm part 10 rotate accordingly with respect to the arm part 10.

In other embodiments (not shown), the actuator 140 may be vertically fixed on the arm part 30. The fixed part of the actuator 140 is fixed to the arm part 30. The movable part of the actuator 140 may be fixed to the adjacent arm part 10. Accordingly, as the rotor of the actuator 140 rotates, the arm parts 20, 30, 40, 50, 60, 70 subsequent to the arm part 10 rotate accordingly with respect to the arm part 10.

According to the present disclosure, the arm parts 10, 20 include modular connection interfaces. Provision of the modular interfaces, assembly work efficiency for assembling the fixed part of the actuator on the arm part and for connecting the arm part to another arm part can be improved. The connection interfaces for the arm parts 10, 20 will be described by referring to FIGS. 3-7.

In the shown example, adjacent to the pair of the arm parts 10, 20, another pair of modular arm configuration, i.e., the two adjacent arm parts 40, 50, are provided. The two adjacent arm parts 40, 50 may be of the same configuration as the pair of the arm parts 10, 20. In the shown example, the pair of the two adjacent arm parts 40, 50 is indirectly fixed to the arm part 20 via an arm part 30. Provision of the arm part 30 can enlarge the work area of the tool. In some other embodiments, the pair of the two adjacent arm parts 40, 50 may be directly fixed to the arm part 20.

In the shown example, the arm part 40 is used as a joint. As shown in FIG. 2, an actuator 120 is fixed to the arm part 40. The actuator 120 includes a fixed part and a movable part. The fixed part, among the others, includes a stator of a motor. The fixed part may include a joint interface for fixing the fixed part to the arm part 40. The fixed part of the actuator 120 is fixed to the arm part 40. The movable part, among the others, includes a rotor of the motor and a reduction gear connected to the rotor. The rotor is configured to rotate around an axial direction (i.e. the vertical direction in the figure). The movable part further includes a joint interface. Components to be driven by the actuator 120, i.e., the arm parts 50, 60, 70 subsequent to the arm part 40, may be further connected to the movable part via the joint interface. The joint formed by the actuator 120 and the arm part 40 is a second revolute joint of the SCARA robot. In the shown example, the second revolute joint is in the vertical direction. Accordingly, as the rotor of the actuator 120 rotates, the arm parts 50, 60, 70 subsequent to the arm part 40 rotate accordingly with respect to the arm part 40.

In other embodiments (not shown), the actuator 120 may be vertically fixed on the arm part 50. The fixed part of the actuator 120 is fixed to the arm part 50. The movable part of the actuator 120 may be fixed to the adjacent arm part 40. Accordingly, as the rotor of the actuator 120 rotates, the arm parts 50, 60, 70 subsequent to the arm part 40 rotate accordingly with respect to the arm part 40.

In the shown example, the arm part 30 is shown as a straight arm part. It is to be understood that the shown example is merely illustrative and the arm part 30 may be of any other proper shapes and any other proper length. In some embodiments, the arm part 30 may be formed as modular configuration different from the modular configuration of the arm parts 10, 20, 40, 50. In some embodiments, the arm part 30 include modular connection interfaces for connecting to adjacent arm parts 20, 40.

In the shown example, adjacent to the pair of the arm parts 40, 50, an arm part 70 for receiving a tool (not shown) may be provided. The arm part 70 may be of the same configuration as any arm part of the pair of the arm parts 10, 20, 40, 50. In the shown example, the arm part 70 is indirectly fixed to the arm part 50 via an arm part 60. Provision of the arm part 60 can further enlarge the work area of the tool. In some other embodiments, the arm part 60 can be omitted and the arm part 60 may be directly fixed to the arm part 20.

In the shown example, the arm part 70 is used as a joint. As shown in FIG. 2, an actuator 130 is fixed to the arm part 70. The actuator 130 includes a fixed part and a movable part. The fixed part, among the others, includes a stator of a motor. The fixed part may include a joint interface for fixing the fixed part to the arm part 40. The fixed part of the actuator 130 is fixed to the arm part 70. The movable part, among the others, includes a rotor of the motor and a reduction gear connected to the rotor. The rotor is configured to rotate around an axial direction (i.e. the vertical direction in the figure). The movable part further includes a joint interface. Components to be driven by the actuator 130, i.e., a tool end flange for receiving a tool may be connected to the movable part via the joint interface. Thus, the tool end flange and thus the tool may be driven to rotate around the axial direction as the rotor of the actuator 130 rotates. The joint formed by the actuator 130 and the arm part 70 is a third revolute joint of the SCARA robot. In the shown example, the third revolute joint is in the vertical direction. Thus, as the actuator 130 rotates, the arm part 70 and the subsequent parts (for example, the tool not shown) rotates around the vertical direction accordingly.

In the shown example, the arm part 60 is shown as a straight arm part. It is to be understood that the shown example is merely illustrative and the arm part 60 may be of any other proper shapes and any other proper length. In some embodiments, the arm part 60 may be formed as the same modular configuration as the arm part 30. This can further improve the modular level of the robot. In some embodiments, the arm part 60 include modular connection interfaces for connecting to adjacent arm parts 50, 70.

As shown in FIGS. 1 and 2, the SCARA robot includes the prismatic joint formed at the first connection interface 112, the first revolute joint formed by the actuator 140 and the arm part 10, the second revolute joint formed by the actuator 120 and the arm part 40, and the third revolute joint formed by the actuator 130 and the arm part 70 is a third revolute joint of the SCARA robot. The SCARA can linearly moves along the base. Rotation direction of the first, second and third revolute joints are along the vertical direction (in the shown example) and are in parallel with each other.

In some embodiments, the arm parts 10, 20, 30, 40, 50, 60, 70 may be made of plastic material. The arm part may be an integral formed member, for example, made by injection molding. When plastic material is used to for forming arm parts, the SCARA robot is resistant to acidic or alkaline, which is beneficial in corrosion resistance applications, such as food, pharmacy industries and the like.

FIGS. 3-7 illustrate different configuration of a modular tubular arm body 200 according to different example embodiments of the present disclosure. It is to be understood that in the shown example the modular tubular arm body is of a bent configuration. The shown interfaces may also be applicable to the straight tubular configuration.

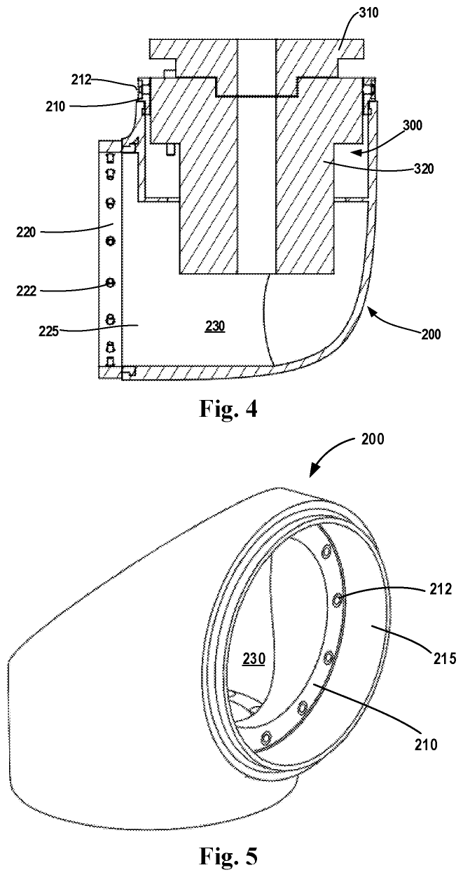

FIGS. 3 and 4 illustrate the modular tubular arm body with two circumferential connections interfaces according to one example of the present disclosure. As shown in FIGS. 3 and 4, the modular arm body 200 includes a tubular body and defines a cavity 230. A first opening 215 is provided at one end of the tubular body and a second opening 225 is provided at an opposite end the tubular body. Two connection interfaces are provided at the first opening 215 and the second opening 225 respectively. The actuator 300 may be inserted into the cavity 230 of the arm body, for example, via the first or second opening. The actuator 300 may include a movable part 310 and a fixed part 320. The tubular body comprises a first circumferential wall 310 extending lengthwise along the tubular body around the first opening 215. The first circumferential wall 310 may include a number of radial through holes 212 for receiving fasteners. When the actuator 300 is placed in position, the fixed part 320 can be fixed to the first circumferential wall 310 via the fasteners. Likewise, the tubular body comprises a second circumferential wall 220 extending lengthwise along the tubular body around the second opening 225. The second circumferential wall 220 may include a number of radial through holes 222 for receiving fasteners. An adjacent arm part may be fixed to the modular arm body 200 via the through holes 222. At least part of the movable part 310 may be exposed from the tubular body. The exposed surfaces of the movable part 310 may include joint interfaces at which another arm part may be connected to the movable part 310 of the actuator.

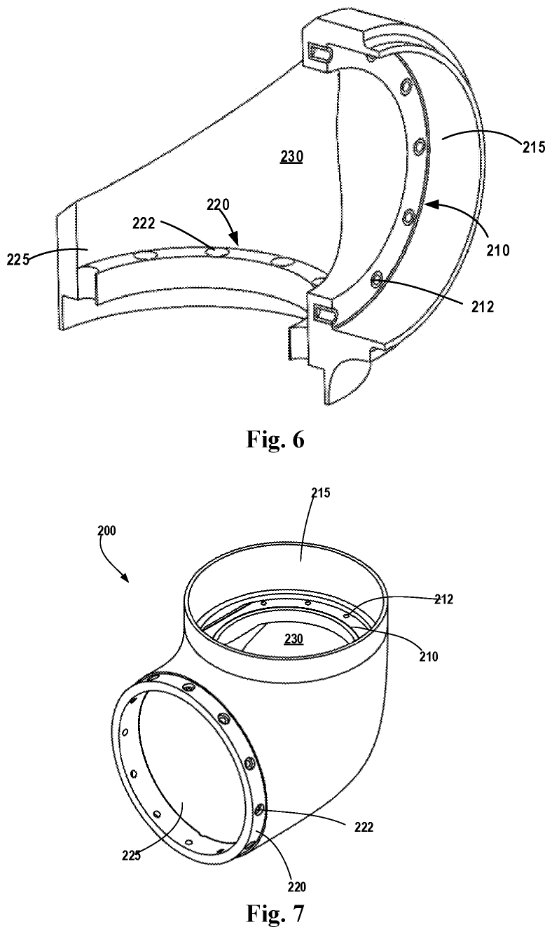

FIGS. 5 and 6 illustrate the modular tubular arm body with two radial connections interfaces according to one example of the present disclosure. As shown in FIGS. 5 and 6, the modular arm body 200 includes a tubular body and defines a cavity 230. A first opening 215 is provided at one end of the tubular body and a second opening 225 is provided at an opposite end the tubular body. Two connection interfaces are provided at the first opening 215 and the second opening 225 respectively. The actuator may be inserted into the cavity of the arm body. The actuator may include a movable part and a fixed part. The tubular body comprises a first inner flange 210 extending radially from an inner wall surface of the tubular body around the first opening 215. The first inner flange may include a number of axial through holes 212 for receiving fasteners. When the actuator is placed in position, the fixed part can be fixed to the first inner flange 210 via the axially extending fasteners. Likewise, the tubular body comprises a second inner flange 220 extending radially from an inner wall surface of the tubular body around the second opening 225. The inner flange 220 may include a number of axial through holes 222 for receiving fasteners. An adjacent arm part may be fixed to the modular arm body 200 via the through holes 222. As shown in FIG. 6, at least part of the movable part 310 may be exposed from the tubular body. The exposed surfaces of the movable part 310 may include joint interfaces at which another arm part 300 may be connected to the movable part 310 of the actuator.

FIG. 7 illustrates the modular tubular arm body with one radial connections interface and one circumferential connections interface. As shown in FIG. 7, the modular arm body 200 includes a tubular body. A first opening 215 is provided at one end of the tubular body and a second opening 225 is provided at an opposite end the tubular body. A radial connection interface is provided at the first opening 215 and a circumferential connections interface is provided at the second opening 225. In some embodiment, the actuator may be fixed to the tubular arm body at one of the radial connection interface and the circumferential connections interface; and the adjacent arm part may be connected to the tubular arm body at the other of the radial connection interface and the circumferential connections interface. In some embodiments, the tubular arm body may be merely used as a link.

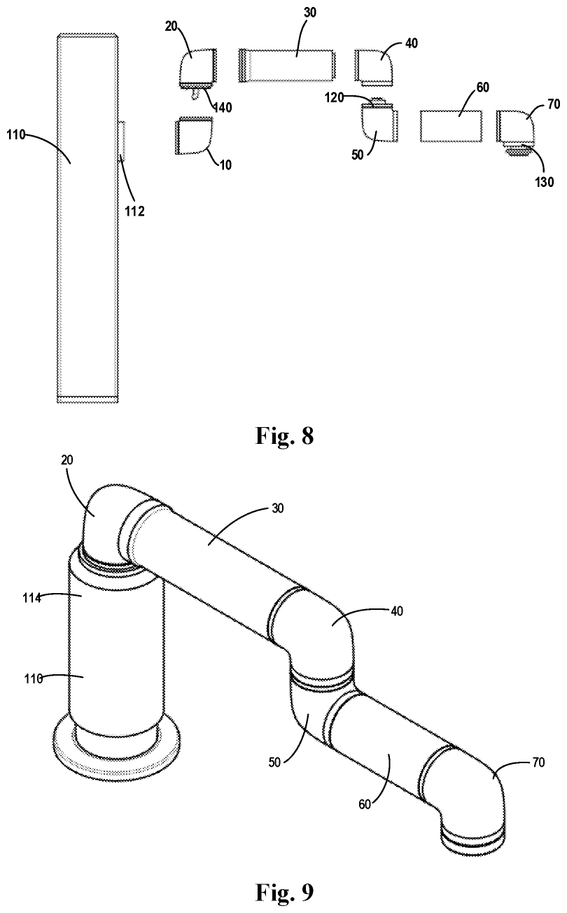

FIG. 8 is a plane exploded view of a SCARA robot according to a second example embodiment of the present disclosure. As shown in FIG. 8, a SCARA robot 1 includes a base 110 and a plurality of arm parts 10, 20, 30, 40, 50, 60, 70. Actuators 120, 130, 140 are arranged in arm parts 50, 70, 20 respectively. The arm part 10 is connected to the base 110 at the first connection interface 112. The first connection interface 112 provides the prismatic joint of SACRA robot. The arm part 10 is fixed to the movable part of the actuator 140. The fixed part of the actuator 140 is fixed to the arm part 20. A first revolute joint is thus formed by the first actuator 140 and the arm part 10. The two adjacent arm part 10, 20 form a pair of modular arm configuration. The two adjacent arm part 10, 20 is indirectly connected to the arm part 40 via an arm part 30. The fixed part of the actuator 120 is fixed to the arm part 50. The movable part of the actuator 140 is fixed to the arm part 40. A second revolute joint is thus formed by the second actuator 130 and the arm part 50. The two adjacent arm part 40, 50 form a pair of modular arm configuration. The two adjacent arm part 40, 50 is indirectly connected to the arm part 70 via an arm part 60. The fixed part of the actuator 130 is fixed to the arm part 70. The movable part of the actuator 130 may be fixed to the end flange for carrying the tool. A third revolute joint is thus formed by the actuator 130 and the arm part 70. The SCARA can linearly moves along the base. Rotation direction of the first, second and third revolute joints are along the vertical direction (in the shown example) and are in parallel with each other.

In the shown example, as shown in FIG. 8, the arm part 10 connected to the base is of bent tubular configuration. The opening of the arm part 10 for connecting to the movable part of the actuator 140 is vertically and upwardly oriented. The adjacent arm part 20 is arranged above the arm part 10. In some other embodiments (not shown), the vertical opening of the arm part 10 for connecting to the movable part of the actuator 140 may be downwardly oriented. The adjacent arm part 20 is arranged below the arm part 10 and thus is connected to the arm part 10 from a downside of the arm part 10. This makes it possible for the adjacent arm parts 20, 30, 40, 50, 60, 70 subsequent to the arm part 10 to move freely from the downside of the arm part 10. The work area of the tool mounted at the arm part 70 can be enlarged. This is advantageous in many applications.

FIG. 9 shows a perspective view of a SCARA robot according to a third example embodiment of the present disclosure. The SCARA robot 1 includes a base 110 and a plurality of arm parts 20, 30, 40, 50, 60, 70. A first actuator (not shown) is vertically arranged in arm part 20. A second actuator (not shown) is vertically arranged in the arm part 40 or the arm part 50. A third actuator (not shown) is vertically arranged in the arm part 70. The base 110 may include a connection interface (not shown). The connection interface of the base 110 provides the prismatic joint of SACRA robot. As shown in FIG. 9, the arm part 20 is of the tubular arm body with a first opening extending in a first direction parallel to the prismatic joint and a second opening extending in a second direction perpendicular to the first direction. A movable part of the first actuator is fixed to the connection interface of the base 110. The fixed part of the first actuator is fixed to the arm part 20. A first revolute joint is thus formed by the first actuator 140 and the arm part 10. The arm part 20 is further connected to a pair of modular arm configuration formed by two adjacent arm parts 40, 50 via the arm part 30. The fixed part of the second actuator may be fixed to the arm part 40 while the movable part of the second actuator is fixed to the arm part 50. Alternatively, the fixed part of the second actuator may be fixed to the arm part 50 while the movable part of the second actuator is fixed to the arm part 40. A second revolute joint is thus formed by the second actuator and the associated arm part. The two adjacent arm part 40, 50 is indirectly connected to the arm part 70 via an arm part 60. The fixed part of the third actuator is fixed to the arm part 70. The movable part of the third actuator may be fixed to the end flange for carrying the tool. A third revolute joint is thus formed by the third actuator and the arm part 70.

In the shown example, the base 110 may include an enclosure 114. The prismatic joint of the base 110 may be arranged in a sealing environment defined by the enclosure 114. This may be needed for high clean room requirements.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A selective compliance assembly robot arm (SCARA) robot, comprising
a base comprising a first connection interface, the first connection interface defining a prismatic joint of the SCARA robot; and
a plurality of arm parts connected to the base and arranged in serial;
wherein at least two adjacent arm parts of the plurality of arm parts each comprise an arm body, the arm body comprising a tubular body with a first opening extending in a first direction parallel to the prismatic joint and a second opening extending in a second direction perpendicular to the first direction, and
a first actuator for forming a first revolute joint of the SCARA robot is arranged in the first opening of one arm part of the two adjacent arm parts, a fixed part of the first actuator being fixed to the one arm part, and a movable part of the first actuator being fixed to the other arm part of the two adjacent arm parts

2. The SCARA robot of claim 1, wherein the two adjacent arm parts are made of plastic material.

3. The SCARA robot of claim 1, wherein the tubular body comprises a first circumferential wall extending lengthwise along the tubular body around the first opening, and the fixed part of the actuator is circumferentially fixed to the one arm part via the first circumferential wall

4. The SCARA robot of claim 3, wherein the tubular body comprises a second circumferential wall extending lengthwise along the tubular body around the second opening, and the other arm part is circumferentially fixed to the second circumferential wall; or
the tubular body comprises an inner flange extending radially from an inner wall surface of the tubular body around the second opening, and the other arm part is fixed to the first inner flange.

5. The SCARA robot of claim 1, wherein the tubular body comprises a first inner flange extending radially from an inner wall surface of the tubular body around the first opening, and the fixed part of the actuator is axially fixed to the first inner flange.

6. The SCARA robot of claim 5, wherein the tubular body comprises a circumferential wall extending lengthwise along the tubular body around the second opening, and the other arm part is circumferentially fixed to the circumferential wall; or
the tubular body comprises a second inner flange extending radially from an inner wall surface of the tubular body around the second opening, and the other arm part is radially fixed to the second inner flange.

7. The SCARA robot of claim 1, wherein the two adjacent arm parts are directly fixed to an arm part, of the plurality of arm parts, for receiving a tool, or is indirectly fixed to the arm part for receiving the tool via a first link arm part.

8. The SCARA robot of claim 7, wherein the arm part for receiving a tool comprises an arm body, the arm body comprising a tubular body with a first opening extending in the first direction parallel to the prismatic joint and a second opening extending in the second direction perpendicular to the first direction, and
a second actuator for forming a second revolute joint of the SCARA robot is arranged in the first opening of the arm part for receiving a tool, a fixed part of the second actuator being fixed to the for receiving the tool, and a movable part of the second actuator configured to receive the tool.

9. The SCARA robot of claim 7, further comprising a second pair of two adjacent arm parts of the plurality of arm parts,
wherein the second pair of two adjacent arm parts is connected to the base at the first connection interface and each comprises an arm body, the arm body comprising a tubular body with a first opening extending in the first direction parallel to the prismatic joint and a second opening extending in the second direction perpendicular to the first direction, and
a third actuator for forming a third revolute joint of the SCARA robot is arranged in the first opening of one arm part of the second pair, a fixed part of the third actuator being fixed to the one arm part of the second pair, and a movable part of the third actuator being fixed to the other arm part of the second pair.

10. The SCARA robot of claim 9, wherein a second pair of two adjacent arm parts is directly fixed to the two adjacent arm parts of the plurality of arm parts, or is indirectly fixed to the two adjacent arm parts of the plurality of arm parts via a second link arm part.

11. The SCARA robot of claim 9, wherein the first opening of an arm part of the second pair of two adjacent arm parts that is adjacent to the base is downwardly oriented.

12. The SCARA robot of claim 7, wherein one arm part, of the plurality of arm parts, connected to the base comprises an arm body comprising a tubular body with a first opening extending in the first direction parallel to the prismatic joint and a second opening extending in the second direction perpendicular to the first direction, and
a third actuator for forming a third revolute joint of the SCARA robot is arranged in the first opening of the one arm part connected to the base, a fixed part of the third actuator being fixed to the one arm part connected to the base, and a movable part of the third actuator is connected to the base at the first connection interface

13. The SCARA robot of claim 1, wherein the base further comprises an enclosure defining a sealing environment in which the prismatic joint is arranged.
